(19) United States
(12) Patent Application Publication
(10) Pub. No.: US 2020/0134330 A1
(43) Pub. Date: Apr. 30, 2020

(54) OBJECT DETECTION SYSTEM AND METHOD

(71) Applicant: Deere & Company, Moline, IL (US)

(72) Inventor: Mark J. Cherney, Potosi, WI (US)

(21) Appl. No.: 16/560,303

(22) Filed: Sep. 4, 2019

Related U.S. Application Data
(60) Provisional application No. 62/751,597, filed on Oct. 27, 2018.

(51) Int. Cl. G06K 9/00; H04N 5/247; G06K 9/62; G08B 21/02; G05D 1/02

(52) U.S. Cl. CPC G06K 9/00805; G06K 9/00369; H04N 5/247; B60R 11/04; G08B 21/02; G05D 1/0214; G06K 9/628

(57) ABSTRACT

An object detection system and method are disclosed. The object detection system comprises at least one image capturing device operably coupled to a work vehicle, wherein the at least one image capturing device is configured to capture images of one or more worksite objects associated with a workman. An electronic data processor is communicatively coupled to the at least one imaging device, the electronic data processor comprising an object recognition device configured to process images received by the image capturing device. A computer readable storage medium comprising machine readable instructions that, when executed by the electronic data processor, cause the object recognition device to: associate a plurality of identifying indicia with the worksite objects; determine an object type of the worksite objects based on the plurality of identifying indicia; and characterize a workman located within a vicinity of the work vehicle based on the determined object type.

### RELATED APPLICATION

This Application claims priority to U.S. Provisional Application No. 62/751,597, titled “Safety Detection System and Method,” filed Oct. 27, 2018, which is hereby incorporated by reference in its entirety.

### FIELD OF THE DISCLOSURE

The present disclosure relates generally to object detection systems, and, more particularly, to an object detection system and method for off-road or industrial vehicles.

### BACKGROUND OF THE DISCLOSURE

In industrial applications, worksite procedures are important for operators, workmen, and other personnel located within the worksite. Generally, industrial standards require that specialized protection equipment be worn. Additionally, effective detection mechanisms are desired to identify the entry of an operator or workman within an area near heavy machinery or equipment.

To address the desire for detection mechanisms, some conventional approaches employ the use of RFID sensors or retroreflective sensors to detect objects, including people, based upon reflective technology. Drawbacks to such approaches include decreased scalability via software, as well as ineffective and limited object differentiation.

As such, there is a need in the art for an improved object detection system that provides increased detection accuracy.

### SUMMARY OF THE DISCLOSURE

According to an aspect of the present disclosure, an object detection system and method is disclosed. The object detection system includes at least one image capturing device operably coupled to a work vehicle, wherein the at least one image capturing device is configured to capture images of one or more worksite objects associated with a workman. An electronic data processor is communicatively coupled to the at least one imaging device, the electronic data processor including an object recognition device that is configured to process images received by the image capturing device. A computer readable storage medium comprising machine readable instructions that, when executed by the electronic data processor, cause the object recognition device to: associate a plurality of identifying indicia with the worksite objects; determine an object type of the worksite objects based on the plurality of identifying indicia; and characterize a workman located within a vicinity of the work vehicle based on the determined object type.

According to another aspect of the present disclosure, a work vehicle having an object detection is disclosed. The work vehicle including a frame; a plurality of ground engaging elements coupled to the frame; and at least one image capturing device operably coupled to the frame. The at least one image capturing device captures images of one or more worksite objects. An electronic data processor communicatively coupled to the at least one imaging device, the electronic data processor comprising an object recognition device configured to process images received by the image capturing device. A computer readable storage medium comprising machine readable instructions that, when executed by the electronic data processor, cause the object recognition device to: associate a plurality of identifying indicia with the worksite objects; determine an object type of the worksite objects based on the plurality of identifying indicia; and characterize a workman located within a vicinity of the work vehicle based on the determined object type.

According to another aspect of the present disclosure, a method is disclosed. The method including capturing, with an image capturing device, one or more images of at least one worksite object. Associating a plurality of identifying indicia with the worksite object. Determining an object type of the worksite object based on the plurality of identifying indicia. Classifying the object type into one or more categories based on a work task associated with the object type; and characterizing a workman located within a vicinity of a work vehicle based on the determined object type.

Other features and aspects will become apparent by consideration of the detailed description and accompanying drawings.

### BRIEF DESCRIPTION OF THE DRAWINGS

The detailed description of the drawings refers to the accompanying figures in which:

FIG. 1 is an illustration of an industrial vehicle including an object detection system according to an embodiment;

FIG. 2 is a block diagram of an object detection system according to an embodiment;

FIG. 3 is a block diagram of a vehicle electronics unit and a remote processing unit according to an embodiment;

FIG. 4 is a block diagram of a vehicle data storage device according to an embodiment; and

FIG. 5 is a flow diagram of a method for identifying worksite objects associated with a workman.

Like reference numerals are used to indicate like elements throughout the several figures.

### DETAILED DESCRIPTION OF THE DRAWINGS

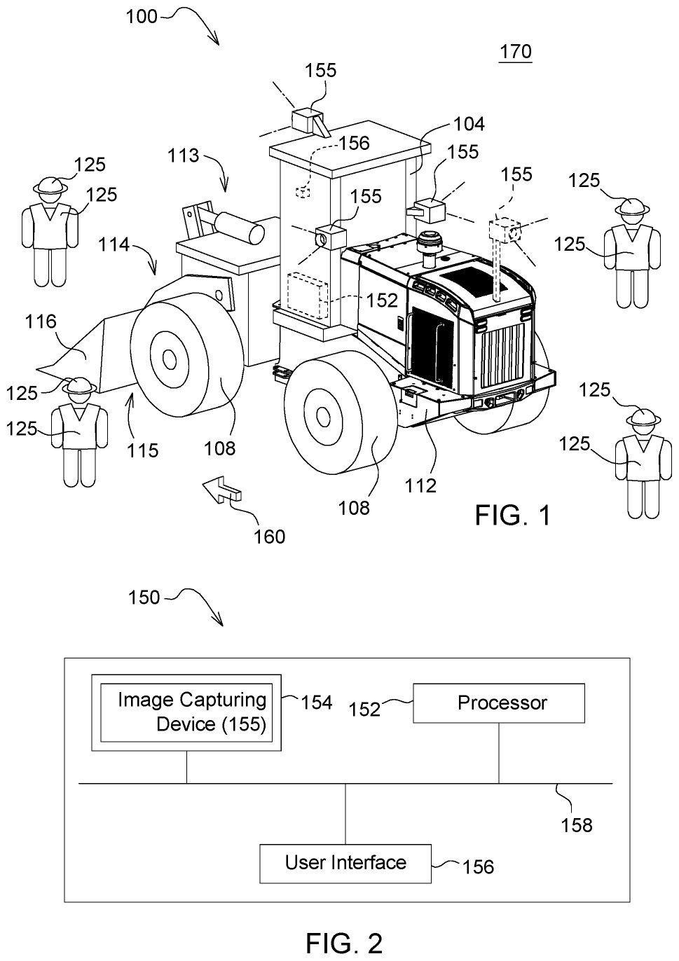

Referring to FIGS. 1 and 2, a work vehicle 100 having an object detection system 150 that helps to identify workmen located within an industrial worksite 170 is shown according to an embodiment. Although the work vehicle 100 is shown as including a construction vehicle (e.g., a loader) in FIG. 1, it should be noted that, in other embodiments, the work vehicle 100 can vary according to application and/or specification requirements. For example, in other embodiments, the work vehicle 100 can include forestry, agricultural, or turf vehicles, with embodiments discussed herein being merely for exemplary purposes to aid in an understanding of the present disclosure.

The work vehicle 100 can comprise a frame 102 and an operator cab 104 supported by wheels 108 or tracks (not shown). A boom assembly 114 can be coupled to the frame 102 and can extend in length between a proximal end 113 and a distal end 115. A bucket structure 116 can be coupled to the boom assembly 114 at its distal end 115 and can comprise a conventional loader bucket as shown. It should be noted, however, that FIG. 1 is but one embodiment and, in other embodiments, the bucket structure 116 may include a ripper, hammer, fork, or other tool for example.

As illustrated in FIG. 2, in some embodiments, the object detection system 150 can be arranged on or within the work vehicle 100 and can comprise an imaging system 154 communicatively coupled to an electronic data processor 152 and user interface 156 via a communication bus 158. In some embodiments, the imaging system 154 can comprise one or more image capturing devices 155 mounted to a frame of the work vehicle 100 and capable of capturing peripheral imaging data. In various embodiments, the image capturing devices 155 can include, without limitation, camera, thermal imager, infrared imaging device, light detection and ranging device (LIDAR), radar device, ultrasonic device, scanner, other suitable sensing devices, or combinations thereof.

The image capturing devices 155 can be mounted to a front of the work vehicle 100 to capture images of one or more worksite objects 125 associated with or worn by a workman located within the worksite 170. In some embodiments, the image capturing devices 155 can have a field of view forward of or to the side of the work vehicle 100. For example, the image capturing device 155 can have a wide field of view that spans approximately 180 to 360 degrees along a center axis of the image capturing device 155 or a structural support attached thereto within a defined range. In other embodiments, one or more of the image capturing devices 155 can be optionally mounted to a rear of the work vehicle 100 in a direction opposite a direction of travel 160 (refer, e.g., to FIG. 1) or other suitable mounting locations. Additionally, in still other embodiments, the imaging system 154 can include a network of image capturing devices 155 arranged locally on the work vehicle 100, a plurality of work vehicles, and/or remotely at various locations throughout the worksite 170, which communicate with one another over wireless, Bluetooth, Ethernet, or other suitable communication protocols.

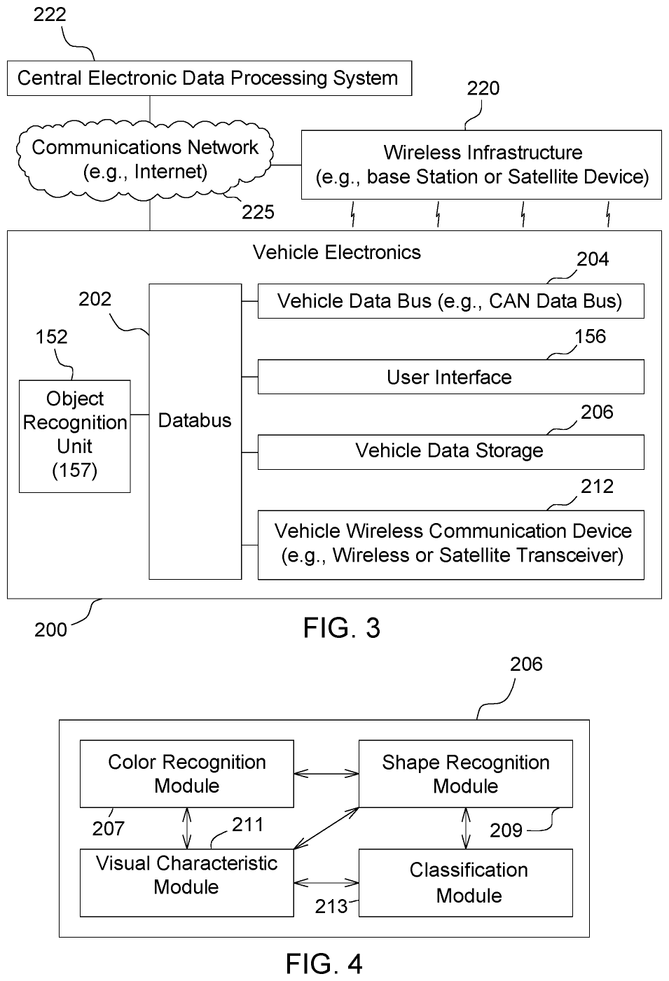

The electronic data processor 152 can be arranged locally as part of a vehicle electronics unit 200 of the work vehicle 100 (FIG. 3) or remotely at a remote processing center 222. In various embodiments, the electronic data processor 152 can comprise a microprocessor, a microcontroller, a central processing unit, a programmable logic array, a programmable logic controller, an application specific integrated circuit, a logic circuit, an arithmetic logic unit, or other suitable programmable circuitry that is adapted to perform data processing and/or system control operations. For example, in some embodiments, the electronic data processor 152 can comprise an object recognition unit 157 that is configured to associate identifying indicia with the image of the worksite objects 125 to determine an object type. For example, the object recognition unit 157 can provide data about the recognized worksite objects 125 to the user interface 156 or other components connected to the communication bus 158.

As will be appreciated by those skilled in the art, FIGS. 1 and 2 are provided for illustrative and exemplary purposes only and are in no way intended to limit the present disclosure or its applications. In other embodiments, the arrangement and/or structural configuration of object detection system 150 can vary. For example, in some embodiments, the object detection system 150 can further comprise one or more aerial imaging devices (e.g., a drone). Additionally, in other embodiments, the object detection system 150 can be configured as a network of image capturing devices arranged on or external to the work vehicle 100 and can also comprise additional sensing capabilities.

Referring now to FIG. 3, in some embodiments, the electronic data processor 152 can be arranged in a vehicle electronics unit 200 and can be configured to associate a plurality of data signals generated by the image capturing device 155. For example, the electronic data processor 152 can process imaging data captured by the image capturing device 155. In addition to the electronic data processor 152, the vehicle electronics unit 200 can comprise a vehicle data storage device 206, a vehicle wireless communications device 212, an operator interface (i.e., user interface 156), and a vehicle data bus 204 each communicatively interfaced with a main data bus 202.

As depicted, the various devices (i.e., vehicle data storage device 206, vehicle wireless communications device 212, user interface 156, and vehicle data bus 204) may communicate information, e.g., signals such as image data over the main data bus 202 to the electronic data processor 152. In other embodiments, the electronic data processor 152 can manage the transfer of data to and from a remote processing system 222 via a network 225 and wireless infrastructure 220. For example, the electronic data processor 152 can collect and process the image data from the main data bus 202 for transmission either in a forward or rearward direction (i.e., to or from processing system 222).

The vehicle data storage device 206 stores information and data for access by the electronic data processor 152 or the vehicle data bus 204. The vehicle data storage device 206 can comprise electronic memory, nonvolatile random-access memory, an optical storage device, a magnetic storage device, or another device for storing and accessing electronic data on any recordable, rewritable, or readable electronic, optical, or magnetic storage medium. Additionally, the vehicle data storage device 206 may include one or more software modules or data structures that record, and store data collected by the image capturing device 155 or other network devices coupled to or capable of communicating with the vehicle data bus 204. For example, in some embodiments, the one or more software modules and/or data structures can comprise a color recognition module 207, a shape recognition module 209, a visual characteristic module 211, and a classification module 213 as will be discussed with reference to FIG. 4.

Referring to FIG. 4, a block diagram of the vehicle data storage device 206 is shown according an embodiment. As discussed with reference to FIG. 3, the object recognition unit 157 can be configured to communicate with the vehicle data storage device 206 to access each of the modules stored therein. For example, the vehicle data storage device 206 can comprise computer executable code that is used to implement the color recognition module 207, the shape recognition module 209, the visual characteristic module 211, and the classification module 213. The term module as used herein may include a hardware and/or software system that operates to perform one or more functions. Each module can be realized in a variety of suitable configurations and should not be limited to any implementation exemplified herein, unless such limitations are expressly called out. Moreover, in the various embodiments described herein, each module corresponds to a defined functionality; however, it should be understood that in other embodiments, each functionality may be distributed to more than one module. Likewise, in other embodiments, multiple defined functionalities may be implemented by a single module that performs those multiple functions, possibly alongside other functions, or distributed differently among a set of modules than specifically illustrated in the examples herein.

In some embodiments, the color recognition module 207 can receive and processes color data such as reflective materials associated with the worksite objects 125 detected in each of the images captured by the image capturing device 155. For example, the color recognition module 207 can be configured to compare color pixels of images of the worksite objects 125 with color data stored in the vehicle data storage device 206 to determine a single color or an array of colors of the worksite objects 125. In other embodiments, the color recognition module 207 can comprise an extraction or sampling circuit (not shown) that extracts color data associated with the captured images.

The shape recognition module 209 communicates with the color recognition module 207 to determine a shape of the worksite objects 125 based on the color data. For example, the shape recognition module 209 can associated various patterns, dimensions, and image coordinates with the color data to determine a geometrical configuration and orientation of the worksite objects 125. Additionally, in some embodiments, the shape recognition module 209 can determine the geometrical configuration of the worksite objects 125 by comparing and/or collating one or more shapes identified within the received images with models stored in the vehicle data storage device 206. The visual characteristic module 211 correlates visual data such as visual cues, environmental data, position data, and other visual data with the color and shape data received from each of the color and shape recognition modules 207, 209. The visual cues can include, without limitation, object size, signage, hand gestures and/or signaling, standing postures of workmen, hand objects (e.g., tools), or other visual indicators associated with the workmen. Workmen located within a vicinity of the work vehicle 100 can perform a variety of tasks that require the use of visual cues. For example, some workmen may be required to hold signs or provide hand gestures to an operator of the work vehicle 100 to provide directional guidance. In some embodiments, the visual characteristic module 211 compares the visual data with stored data to determine one or more characteristics of the worksite object 125.

In some embodiments, the classification module 213 may comprise a classifier unit or other device that is configured to classify and associate data received from each of the color recognition module 207, shape recognition module 209, and visual characteristic module 211 to generate 2D or 3D models of the worksite objects 125. For example, the classification module 213 can classify each of the worksite objects 125 into one or more categories or subgroups based on an identified object type (e.g., hat, vest, sign, etc.) and a workman associated with the object type.

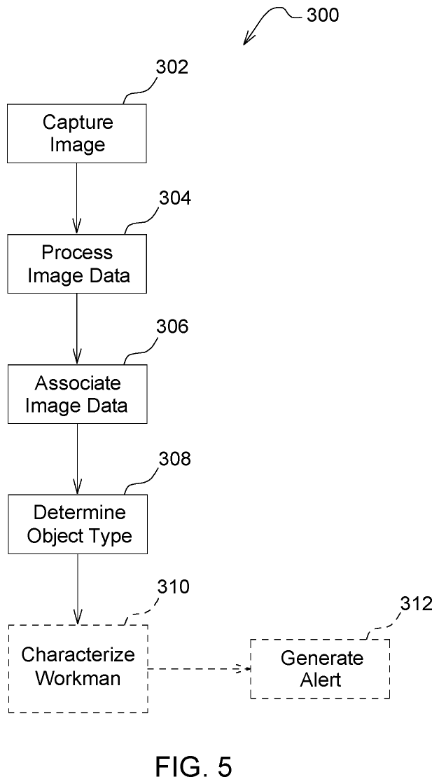

In operation, referring now to FIG. 5, a flow diagram of a method 300 for identifying one or more objects captured in an image is shown. At 302, the image capturing device 155 can be configured to manually or automatically span a defined range within, e.g., a 360° radius to capture one or more images of objects associated with workmen located within the worksite 170. For example, for manual operations, upon receipt of an input via the operator interface 106, the image capturing device 155 captures images of the worksite 170 at 302 to determine if any workmen are located within a peripheral area around the work vehicle 100. In other embodiments, such as when the system is in automatic mode, the image capturing device 155 can be configured to receive an initiation bit or handshake from the electronic data processor 152 upon vehicle startup to begin capturing image data. This, in turn, also adjusts the field of view based on a detected scenery or surroundings.

Once the one or more images are captured at 302, the image data is transmitted to the electronic data processor 152 for processing at 304. During processing, the color, shape, and visual characteristic data is associated to determine the object type (e.g., reflective hat or vest) and proximate location of the worksite objects 125 at 306. For example, as discussed with reference to FIG. 4, each of the modules (i.e., color recognition module 207, shape recognition module 209, and visual characteristic module 211) can be configured to implement various functionalities and interface with one another to identify the color, shape, and visual characteristics of the worksite objects 125.

Next at 308, once the various characteristics of the worksite objects 125 are identified at 306, further classification is performed by the classification module 213, and a comparative analysis of the captured images and stored reference images is completed by the electronic data processor 152 to determine the type of the worksite objects 125. Although in FIG. 1 the worksite objects 125 are shown as including hats and vests (e.g., reflective hats and vests), it should be noted that, in other embodiments, the worksite objects 125 can include a variety of identifying objects with FIG. 1 being but one exemplary embodiment. For example, in other embodiments, the object detection system 150 can be configured to identify other objects or workmen without reflective vests or hats, or to fuse the collected imaging data with other sensor data for a more comprehensive perception feature set. Once the object type is determined at 308, the classification module 213 can determine a category of workmen associated with the object type at 310. For example, the workmen can be characterized into various groups based on more or more tasks associated with the object type.

Following determination of the worksite object 125, a second peripheral scan can be completed to determine a position of one or more workmen relative to the work vehicle 100. For example, in some embodiments, the work vehicle 100 can further comprise one or more sensors such as proximity sensors mounted to the vehicle that detects a position or presence of one or more workmen relative to the work vehicle 100. Optionally at 312, an alert is generated by the electronic data processor 152 and displayed on the user interface 156, if, based on sensor feedback, it is determined that a workman is within a predetermined danger zone (e.g., too close) relative to the work vehicle 100. In other embodiments, a work function of the work vehicle 100 can be inhibited based upon the alert generated at 312. In addition to the alert being visual, the alert may be audible, haptic, or other, or any combination.

Without in any way limiting the scope, interpretation, or application of the claims appearing below, a technical effect of one or more of the example embodiments disclosed herein is an object detection system. The object detection system is particularly advantageous in that it provides real-time monitoring of an industrial worksite by detecting one or more worksite objects to identify workmen located around work vehicles on construction, forestry, industrial and other worksites.

While the above describes example embodiments of the present disclosure, these descriptions should not be viewed in a limiting sense. Rather, other variations and modifications may be made without departing from the scope and spirit of the present disclosure as defined in the appended claims.

What is claimed is:

1. An object detection system for a work vehicle, the object detection system comprising:
at least one image capturing device operably coupled to a work vehicle, wherein the at least one image capturing device is configured to capture images of one or more worksite objects;
an electronic data processor communicatively coupled to the at least one imaging device, the electronic data processor comprising an object recognition device configured to process images received by the image capturing device; and
a computer readable storage medium comprising machine readable instructions that, when executed by the electronic data processor, cause the object recognition device to:
associate a plurality of identifying indicia with the worksite objects;
determine an object type of the worksite objects based on the plurality of identifying indicia; and
characterize a workman located within a vicinity of the work vehicle based on the determined object type.

2. The object detection system of claim 1, wherein the worksite object comprises at least one of a reflective vest or a reflective hat.

3. The object detection system of claim 1, wherein the imaging device comprises at least one of a camera, a thermal imager, a LIDAR, a radar, an ultrasonic, an infrared imaging device, a video recorder, or combinations thereof.

4. The object detection system of claim 1, wherein the identifying indicia comprises at least one of an object color, an object shape, a visual characteristic, or combinations thereof.

5. The object detection system of claim 4, wherein the visual characteristic comprises a visual cue including one or more of the following: object size, signage, hand gesture, hand object, workman standing posture, or combinations thereof.

6. The object detection system of claim 1, wherein characterizing the workman comprises categorizing the workman based on a task associated with the object type.

7. The object detection system of claim 1, further comprising at least one proximity sensor mounted to the work vehicle, wherein the proximity sensor is configured to detect the location of a workman relative to the work vehicle.

8. The object detection system of claim 7, wherein an alert is generated by the electronic data processor for display on a user interface when the workman is within a predetermined danger zone relative to the work vehicle.

9. The object detection system of claim 7, wherein a work function of the work vehicle is inhibited when the workman is within a predetermined danger zone relative to the work vehicle.

10. A work vehicle, the work vehicle comprising:
a frame;
a plurality of ground engaging elements coupled to the frame;
at least one image capturing device operably coupled to the frame, wherein the at least one image capturing device is configured to capture images of one or more worksite objects;
an electronic data processor communicatively coupled to the at least one imaging device, the electronic data processor comprising an object recognition device configured to process images received by the image capturing device; and
a computer readable storage medium comprising machine readable instructions that, when executed by the electronic data processor, cause the object recognition device to:
associate a plurality of identifying indicia with the worksite objects;
determine an object type of the worksite objects based on the plurality of identifying indicia; and
characterize a workman located within a vicinity of the work vehicle based on the determined object type.

11. The work vehicle of claim 10, wherein the at least one image capturing device comprises a network of image capturing devices arranged on a plurality of work vehicles.

12. The work vehicle of claim 11, wherein the imaging device comprises at least one of a camera, a thermal imager, a LIDAR, a radar, an ultrasonic, an infrared imaging device, a video recorder, or combinations thereof.

13. The work vehicle of claim 10, wherein the worksite object comprises at least one of a reflective vest or a reflective hat.

14. The work vehicle of claim 10, wherein the identifying indicia comprises at least one of an object color, an object shape, a visual characteristic, or combinations thereof.

15. The work vehicle of claim 14, wherein the visual characteristic comprises a visual cue including one or more of the following: object size, signage, hand gesture, hand object, workman standing posture, or combinations thereof.

16. The work vehicle of claim 10, wherein characterizing the workman comprises categorizing the workman based on a task associated with the object type.

17. The work vehicle of claim 10, further comprising at least one proximity sensor mounted to the work vehicle, wherein the proximity sensor is configured to detect the location of a workman relative to the work vehicle.

18. A method comprising:
capturing, with an image capturing device, one or more images of at least one worksite object;
associating a plurality of identifying indicia with the worksite object; determining an object type of the worksite object based on the plurality of identifying indicia;
classifying the object type into one or more categories based on a work task associated with the object type; and
characterizing a workman located within a vicinity of a work vehicle based on the determined object type.

19. The method of claim 18, wherein the identifying indicia comprises at least one of an object color, an object shape, a visual characteristic, or combinations thereof.

20. The method of claim 18, wherein determining the object type further comprises generating a two-dimensional or three-dimensional model of the worksite object for display on a user interface, and wherein characterizing the workman comprises categorizing the workman based on a task associated with the object type.
